(19) United States
(12) Patent Application Publication
(10) Pub. No.: US 2003/0142747 A1
(43) Pub. Date: Jul. 31, 2003

(54) INTER-PICTURE COMPRESSION ENCODING APPARATUS AND ENCODING METHOD

(76) Inventors: KOJI OBATA, TOKYO (JP); NOBUHIRO IGI, KANAGAWA (JP); MOTOKI KATO, KANAGAWA (JP)

Correspondence Address: FROMMER LAWRENCE & HAUG, 745 FIFTH AVENUE- 10TH FL., NEW YORK, NY, 10151, US

(21) Appl. No.: 09/275,596

(22) Filed: Mar. 24, 1999

(30) Foreign Application Priority Data
Mar. 26, 1998 (JP) 10-079217

(51) Int. Cl. H04N 7/12

(52) U.S. Cl. 375/240.13; 375/240.15

(57) ABSTRACT

A bit stream generated in a first encoding process is supplied to an MPEG decoder. The MPEG decoder outputs decoded pictures. The decoded pictures are supplied as input decoded pictures to a frame memory through a recording/reproducing system. The frame memory supplies the input decoded pictures to an MPEG encoder and an MAD calculating circuit at a predetermined timing. The MAD calculating circuit calculates a MAD value (the sum of the differences between a mean value and each pixel value). A high pass filter extracts high frequency components from the input decoded pictures corresponding to the calculated result. The extracted high frequency components are supplied to a B picture determining circuit. The B picture determining circuit determines the picture type of the input decoded pictures corresponding to the high frequency components and supplies the determined result to the MPEG encoder. The MPEG encoder locks GOP phases of the input decoded pictures corresponding to the determined result.

### BACKGROUND OF THE INVENTION

1. Field of the Invention

The present invention relates to an inter-picture compression encoding apparatus suitable for an application that requires high picture quality.

2. Description of the Related Art

In an editing process for joining an encoded video signal that has been recorded or transmitted corresponding to MPEG (Moving Picture Expert Group) standard, the encoded video signal is sometimes re-encoded in the vicinity of an edited point. In the re-encoding process, a picture signal is encoded in an inter-picture compression encoding method corresponding to the MPEG standard. The encoded picture signal is decoded and thereby decoded pictures are obtained. The decoded pictures are re-encoded corresponding to the MPEG standard. In the re-encoding process, the picture quality of pictures that have been re-encoded tends to deteriorate in comparison with the picture quality of pictures that has been encoded for a normal video signal.

It is known that such deterioration of picture quality takes place in the case that an encoding sequence and various encoding parameters such as a moving vector in the first encoding process corresponding to the MPEG standard are different from those in the re-encoding process, particularly, in the case that the a GOP (Group Of Picture) phase in the first encoding process is different from that in the re-encoding process.

### OBJECTS AND SUMMARY OF THE INVENTION

Therefore, an object of the present invention is to provide an inter-picture compression encoding apparatus and an encoding method for suppressing deterioration of picture quality due to the deviation of an GOP phase in the first encoding process and an GOP phase in the re-encoding process.

A first aspect of the present invention is an inter-picture compression encoding apparatus, comprising an inputting means for receiving decoded pictures, a picture type information generating means for generating a signal that represents a picture type corresponding to the decoded picture, and a GOP phase deviation determining means for determining the deviation of GOP phases corresponding to the output signal of said picture type information generating means.

A second aspect of the present invention is an inter-picture compression encoding apparatus, comprising an inputting means for receiving decoded pictures, an encoding means for encoding the decoded pictures, a decoding means for decoding encoded pictures so as to generate re-decoded pictures, a picture quality deterioration evaluating means for calculating a value that represents the deterioration of the picture quality for each picture of a GOP corresponding to the decoded pictures and the re-decoded pictures, and a GOP phase deviation detecting means for detecting the deviation of GOP phases corresponding to a value that represents the deterioration of the picture quality.

A third aspect of the present invention is an inter-picture compression encoding method, comprising the steps of receiving decoded pictures, generating a signal that represents a picture type corresponding to the decoded pictures, and determining the deviation of GOP phases corresponding to the output signal at the picture type information generating step.

A fourth aspect of the present invention is an inter-picture compression encoding method, comprising the steps of receiving decoded pictures, encoding the decoded pictures, decoding encoded pictures so as to generate re-decoded pictures, calculating a value that represents the deterioration of the picture quality for each picture of a GOP corresponding to the decoded pictures and the re-decoded pictures, and detecting the deviation of GOP phases corresponding to a value that represents the deterioration of the picture quality.

According to the first and third aspects of the present invention, the picture type of each picture of an input decoded pictures is determined corresponding to a value that represents an information amount assigned to each picture of an encoded signal in the first encoding process. With reference to the determined result, a process for locking a GOP phase in the first encoding process with a GOP phase in the re-encoding process can be performed.

According to the second and fourth aspects of the present invention, the deviation of a GOP phase in the first encoding process from a GOP phase in the re-encoding process can be determined corresponding to decoded pictures and re-decoded pictures. In addition, with reference to the determined result, a process for locking a GOP phase in the first encoding process with a GOP phase in the re-encoding process can be performed.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIGS. 1A, 1B, and 1C are schematic diagrams for explaining deterioration of picture quality due to the deviation of a GOP phase in a first encoding process from a GOP phase in a re-encoding process;

FIG. 2 is a block diagram for explaining a MAD calculating method according to a first embodiment of the present invention;

FIG. 3 is a graph showing an example of MAD values calculated for individual pictures;

FIG. 4 is a graph showing an example of a signal of which MAD values calculated for individual pictures shown in FIG. 7 are filtered;

FIG. 5 is a graph showing an example of a mean value MAD values for each GOP along with an example of a signal shown in FIG. 8;

FIG. 6 is a first part of a flow chart showing an example of a process for determining a picture type according to the first embodiment of the present invention;

FIG. 7 is a second part of the flow chart shown in FIG. 6;

FIG. 8 is a block diagram for explaining the structure according to the first embodiment of the present invention;

FIG. 9 is a graph for explaining the difference of an SNR value in the case that GOP phases lock in the first encoding process and the re-encoding process from an SNR value in the case that B picture phases deviate in the first encoding process and the re-encoding process;

FIG. 10 is a graph for explaining the difference of an SNR value in the case that GOP phases lock in the first encoding process and the re-encoding process from an SNR value in the case that I picture phases or P picture phases deviate in the first encoding process and the re-encoding process;

FIG. 11 is a flow chart for explaining a process for determining the deviation of GOP phases according to a second embodiment of the present invention; and

FIG. 12 is a block diagram for explaining the structure of the second embodiment of the present invention.

### DETAILED DESCRIPTION OF THE PREFERRED EMBODIMENTS

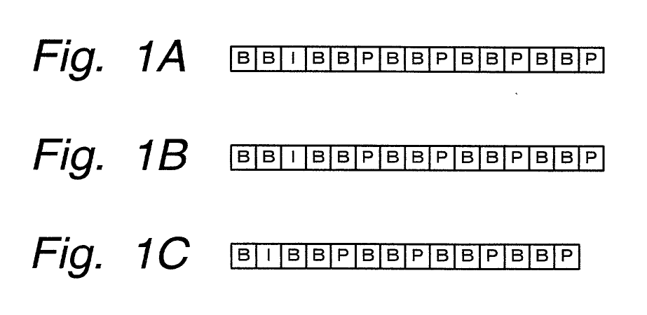

According to the present invention, to reduce deterioration of picture quality in the re-encoding process, a GOP phase in the first encoding process is locked with a GOP phase in the re-encoding process. FIG. 1A shows an example of decoded pictures that are re-encoded. In this example, it is assumed that the number of pictures of one GOP is 15 (namely, n=15).

When GOP phases are locked as shown in FIG. 1B, an I picture or a P picture (shown in FIG. 1A) of decoded pictures that are re-encoded is used as a reference picture for the re-encoding process. In this case, since an I picture or a P picture that does not largely deteriorate in picture quality is used as a reference picture for the re-encoding process, picture quality of pictures that are re-encoded can be suppressed from deteriorating.

On the other hand, when GOP phases are not locked as shown in FIG. 1C, a B picture is treated as an I picture or a P picture as the third and sixth pictures. Thus, since a B picture that largely deteriorate in picture quality is used as a reference picture for the re-encoding process, the accuracy of the re-encoding process lowers and the picture quality largely deteriorates.

To suppress the picture quality from deteriorating in the re-encoding process, a GOP phase in the first encoding process should be locked with a GOP phase in the re-encoding process. However, decoded pictures do not have a flag that represents a delimiter of a GOP (for example, a flag that represents the position of the first I picture). Thus, to lock the GOP phases, it is necessary to determine the deviation of a GOP phase in the first encoding process from a GOP phase in the re-encoding process or the picture type of each picture of decoded pictures for the re-encoding process.

Therefore, in the first embodiment of the present invention, the picture type of each picture is determined corresponding to MPEG decoded pictures for the re-encoding process (the MPEG decoded pictures are referred to as input decoded pictures). Corresponding to the determined result, the state of which B picture phases deviate is detected (hereinafter, this state is referred to as state of which GOP phases fully deviate).

Next, the first embodiment of the present invention will be described. In a system corresponding to the MPEG standard, so as to improve the subjective picture quality in the encoding process (namely, to allow deterioration of picture quality of reproduced pictures to be unobtrusive from a viewer's standpoint), the picture quality of B pictures is slightly lowered, whereas the picture quality of I and P pictures is slightly raised. In reality, the encoding process is performed so that the quantizing scale of B pictures is larger than the quantizing scale of I and P pictures. In the quantizing process, AC components that are discarded are proportional to the quantizing scale. Thus, the quantity that represents AC components is calculated for each of decoded pictures. When the calculated value of a picture is smaller than a predetermined value, the picture can be determined as a B picture.

As a quantity that represents AC components, for example, the difference of a mean value and each pixel value is obtained. Thereafter, the sum of the differences is obtained. The sum is referred to as MAD value. To calculate the MAD value of each picture, the MAD value of each block (defined in the MPEG standard as will be described later) is obtained. Thereafter, the sum of the MAD values of all the blocks of the picture is calculated as the MAD value of the picture.

To calculate the MAD value for each block, the MAD value for each field is obtained. The sum of the MAD values of all the fields is obtained as the MAD value of each block. In such a calculating method, the following situation is considered. In the case that the MAD value for each frame is calculated in each block, when a picture that largely moves is a B picture, the MAD value becomes large. Thus, the calculated value may contain an error.

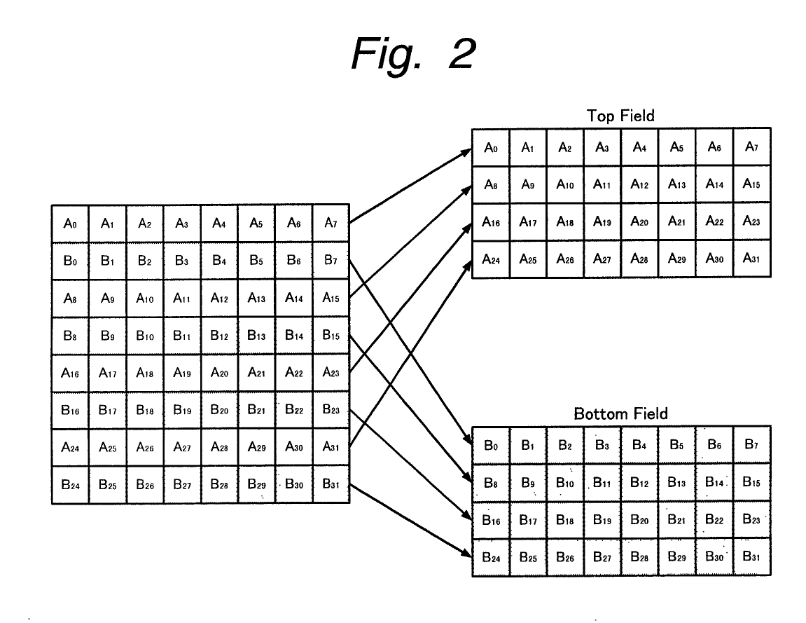

Next, with reference to FIG. 2, a method for calculating the MAD value for each block will be described in detail. Corresponding to the MPEG standard, each block is composed of eight pixels×eight lines. In FIG. 2, each pixel has a code that represents a pixel value. In other words, pixels in the top field are denoted by A0, A2, . . . , A31. Pixels in the bottom field are denoted by B0, B2, . . . , B31. At this point, MAD_{Top} (that is the MAD value of the top field) and MAD_{Bottom} (that is the MAD value of the bottom field) are calculated corresponding to formulas (1) and (2), respectively.

$${MAD}_{Top} = {\sum }_{i = 0}^{Num} \vert Ai - {Mean}_{Top} \vert \qquad ( 1 )$$

where the means value MEAN_{Top} of the top field is expressed as follows:

$$\begin{matrix}{Mean}_{Top} = \frac{{\sum }_{i = 0}^{Num} Ai}{Num} \\ {MAD}_{Bottom} = {\sum }_{i = 0}^{Num} \vert Bi - {Mean}_{Bottom} \vert\end{matrix} \qquad ( 2 )$$

where the means value MEAN_{Bottom} for the bottom field is expressed as follows:

$${Mean}_{Bottom} = \frac{{\sum }_{i = 0}^{Num} Bi}{Num}$$

where Num is the number of pixels in each field.

MAD_{Block} (that is the MAD value for each block) and MAD_{Pict} (that is the MAD value for each picture) are calculated corresponding to formulas (3) and (4):

$$\begin{matrix}{MAD}_{Block} = {MAD}_{Top} + {MAD}_{Bottom} & ( 3 ) \\ {MAD}_{Pict} = {\sum }_{i = 0}^{BNum} {MAD}_{block} [ i ] & ( 4 )\end{matrix}$$

where MAD_{Block} is the MAD value for the i-th block; and Bₙᵤₘ is the number of blocks of the current picture.

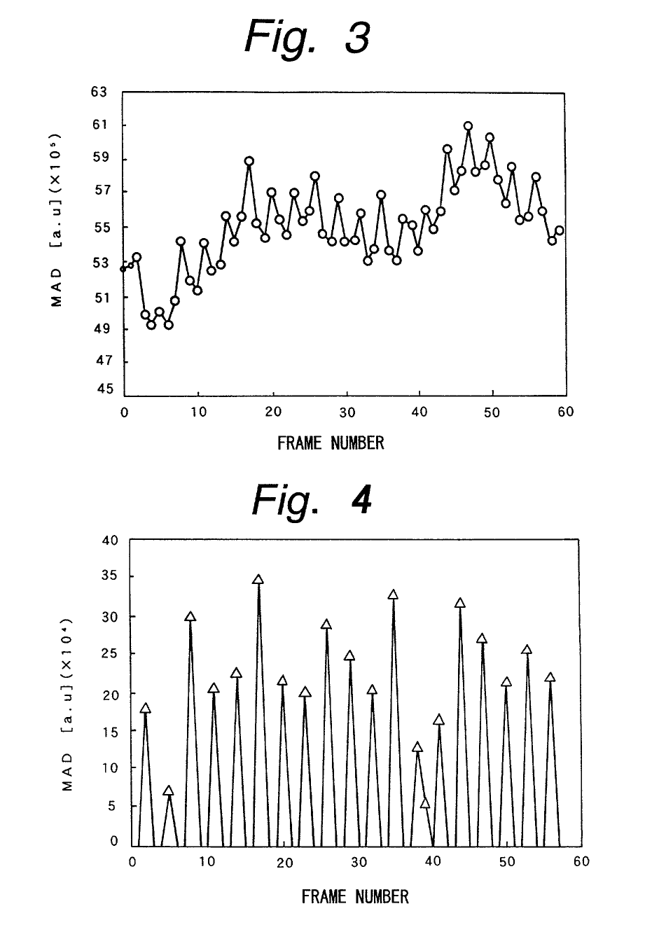

FIG. 3 is a graph showing MAD values in the case that a bicycle is used as a test picture. In FIG. 3, the horizontal axis represents frame numbers. The test picture bicycle is one of a standard sequence used for determining the deterioration of picture quality in a standard of Comitè Consultatif International Radiophonique (CCIR). Each GOP is structured as n=15 and m=3. In this case, the variation of the MAD values due to the variation of the picture type is superimposed with the variation of the MAD values due to the variation of the picture. Thus, it is difficult to determine the picture type of each picture.

Since the frequency of the variation of the MAD values due to the variation of the picture type is higher than the frequency of the variation of the MAD values due to the variation of pictures, only the variation of the MAD values due to the variation of the picture type is extracted with a high pass filter. As a real example, a high pass filter with three taps [−1/2, 1, and −1/2] is used. FIG. 4 is a graph showing an example of a signal in the case that when an output value of the filter is a negative value, the output value is treated as 0. The high pass filter is not limited to the above-described example as long as the variation of the MAD values due to the variation of the picture type can be extracted.

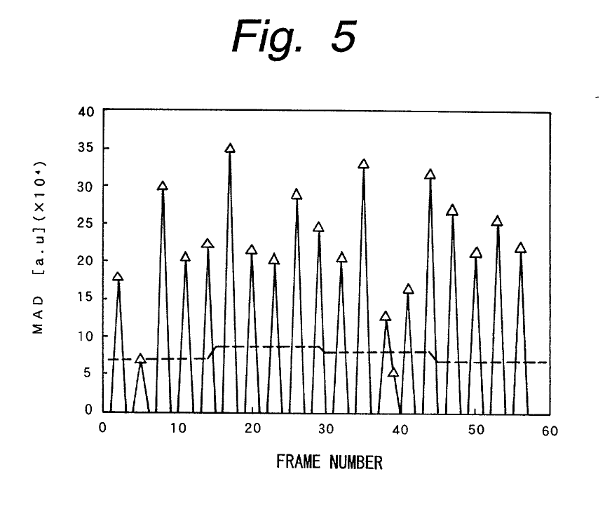

In the resultant signal, a picture with a value lower than the predetermined threshold value can be determined as a B picture. The threshold value may be the mean value for several pictures to one GOP. FIG. 5 is a graph showing the mean value of MAD values of one GOP along with the MAD values shown in FIG. 4. In FIG. 5, the mean value of the MAD values of one GOP is denoted by a dashed line. As is clear from FIG. 5, the MAD values of I pictures and P pictures are peak values. The MAD values of B pictures are smaller than the mean value. Thus, when the mean value of the MAD values for one GOP is defined as a threshold value, a B picture can be determined. Corresponding to the determined result, B picture phases can be locked.

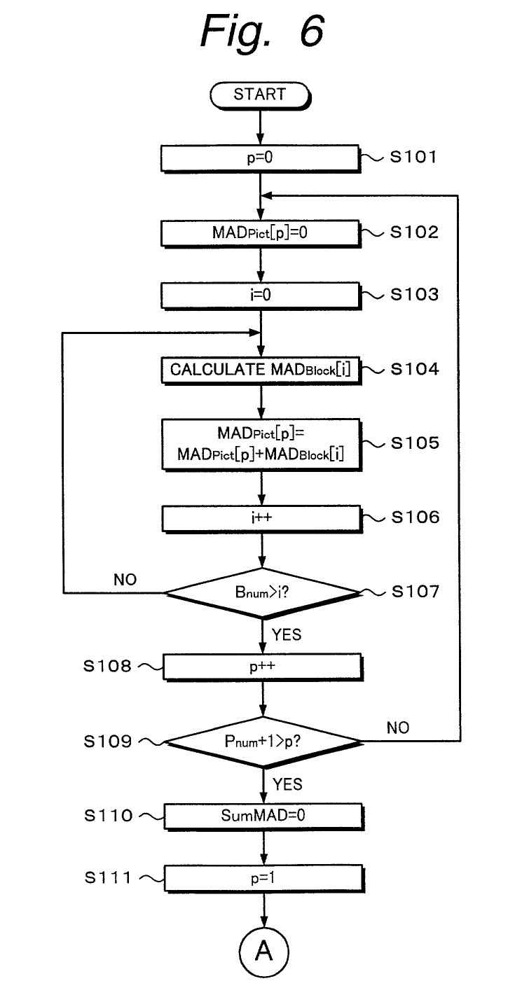

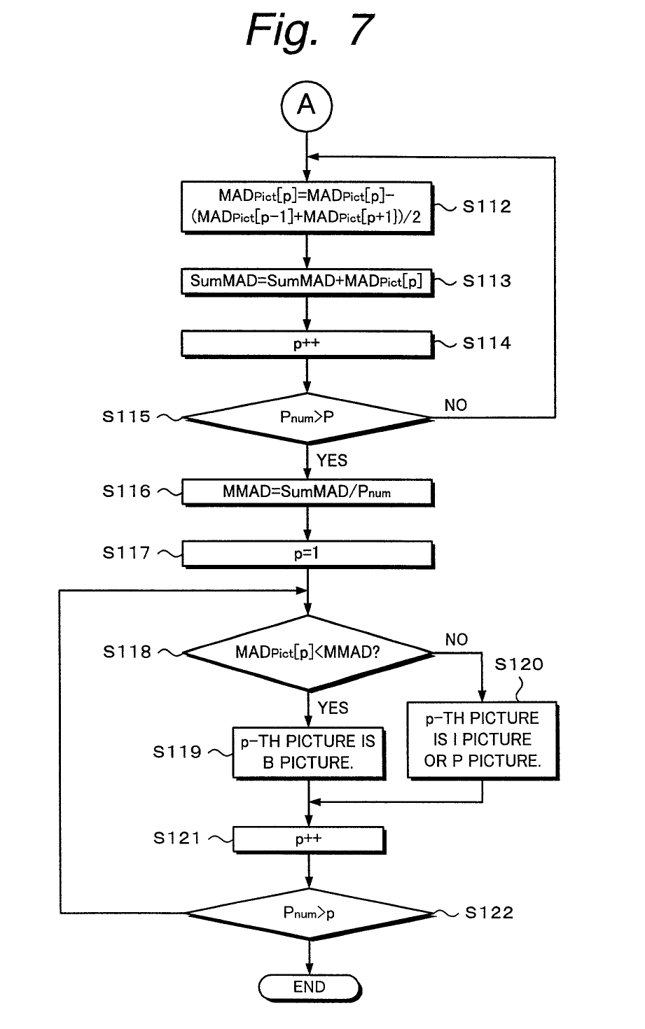

Next, with reference to FIGS. 6 and 7, a process for locking B picture phases according to an embodiment of the pressent invention will be described. FIGS. 6 and 7 are a first part and a second part of a flow chart for the process, respectively. After the process is started, at step S101, variable p that represents a picture number of in a GOP is initialized (namely, p=0). At step S102, variable MAD_{Pict} [p] that represents the MAD value of the p-th picture is initialized (namely, MAD_{Pict} [p]=0). At step S103, the block number i of the current picture is initialized (namely, i=0).

At step S104, MAD_{Block} [i] (namely, the MAD value of the i-th block) is calculated. At step S105, the value of MAD_{Block} [i] calculated at step S104 is added to MAD_{Pict} [p]. At step S106, the value of i is incremented. At step S107, it is determined whether or not the value of i is smaller than the number of blocks Bₙᵤₘ of the current picture. When the determined result at step S107 is Yes, the flow advances to step S104. At step S104, the next block is processed. Thus, a loop of step S104 to step S107 is repeated for the number of blocks Bₙᵤₘ of the current picture. Thus, the variable MAD_{Pict} that represents the MAD value of the p-th picture is calculated.

On the other hand, when the determined result at step S107 is No, the calculations of the MAD values for the p-th picture have been completed. Thus, the MAD values for the next picture are calculated. In other words, at step S108, the value of p is incremented. At step S109, it is determined whether or not the value of p is smaller than Pₙᵤₘ+1 (where Pₙᵤₘ is the number of pictures of one GOP).

The value of p is compared with Pₙᵤₘ+1 because the MAD values for Pₙᵤₘ+1 (in this case, Pₙᵤₘ=15) should be calculated for a filtering process at step S112. When the determined result at step S109 is Yes, the flow advances to step S102. At step S102, the next picture is processed.

On the other hand, when the determined result at step S109 is No, a process for detecting the deviation of B picture phases of the current GOP is performed. At step S110, the value of variable SumMAD corresponding to the sum of the MAD values of one GOP is initialized (namely, SumMAD=0). At step S111, variable p that represents the picture number of the current GOP is initialized (namely, p=1). The initialization of p=1 is performed corresponding to the filtering process at step S112. Next, with reference to FIG. 7, the second part of the flow chart will be described. Step S111 shown in FIG. 6 is followed by step S112 shown in FIG. 7.

At step S112, the filtering process is performed for MAD_{Pict} [0] to MAD_{Pict} [15]. In this example, at step S112, the above-described high pass filter with three taps [−1/2, 1, and −1/2] is used. In other words, calculations for the filtering process are performed corresponding to three successive values of MAD_{Pict} [0] to MAD_{Pict} [15]. For example, corresponding to p=1, MAD_{Pict} [1]−(MAD_{Pict} [0]+MAD_{Pict} [2])/2 is calculated. The calculated result is set to MAD_{Pict} [1]. As described above, the present invention is not limited to such a filtering process.

At step S113, the value of MAD_{Pict} [p] obtained in the filtering process at step S112 is added to the value of SumMAD. At step S114, the value of p is incremented. At step S115, it is determined whether or not the value of p is smaller than Pₙᵤₘ. When the determined result at step S115 is Yes, the flow advances to step S112. At step S112, the filtering process is performed for the value of p incremented at step S114 and the filtered result is added to the value of SumMAD.

On the other hand, when the determined result at step S115 is No, since the calculations for SumMAD of the current GOP have been completed, the flow advances to step S116. At step S116, the value of SumMAD is divided by the value of Pₙᵤₘ. Thus, the value of MMAD that is the mean value of the MAD values of one GOP is calculated.

In a portion at step S117 and later, with reference to the value of MMAD calculated at step S116, the picture type of each picture of one GOP is determined. At step S117, the value of p is initialized (namely, p=1). At step S118, it is determined whether or not the value of MAD_{Pict} [p] is smaller than the value of MMAD. When the determined result at step S118 is Yes, the flow advances to step S119. At step S119, the p-th picture is determined as a B picture. Corresponding to the determined result, a signal that represents the picture type is generated.

On the other hand, when the determined result at step S118 is No, the flow advances to step S120. At step S120, the p-th picture is determined as an I picture or a P picture. Corresponding to the determined result, a signal that represents the picture type is generated.

After step S119 or S120, the flow advances to step S121. At step S121, the value of p is incremented. At step S122, it is determined whether or not the value of p is smaller than Pₙᵤₘ. When the determined result at step S122 is Yes, the flow advances to step S118. At step S118, the picture type of the next picture is determined. On the other hand, when the determined result at step S122 is No, since the picture type of each of the pictures of the GOP has been determined, the process is completed.

In the above-described process, as a reference value for determining the picture type of each picture, the mean value of MAD values of one GOP was used. Alternatively, as described above, the means value of MAD values of several pictures may be used. In addition, the picture type may be determined every several GOPs rather than each GOP.

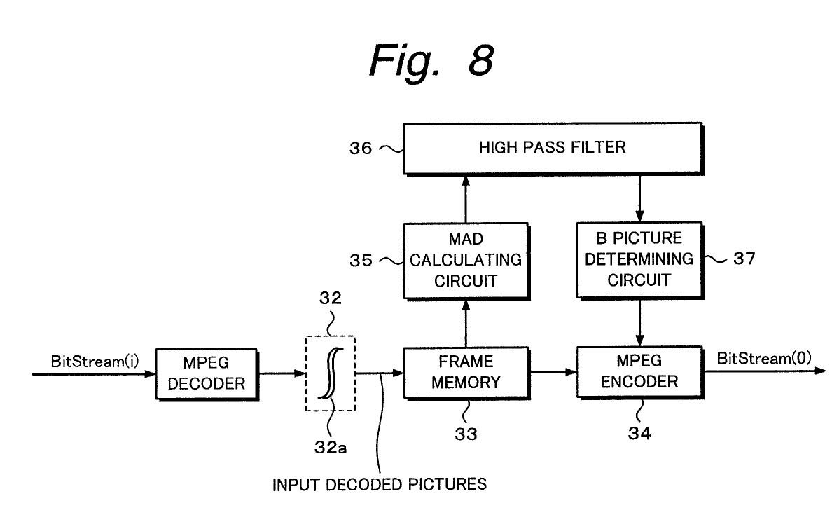

Next, with reference to FIG. 8, the structure of the first embodiment of the present invention will be described. A bit stream (i) generated in the first encoding process is supplied to an MPEG decoder 31. The MPEG decoder 31 decodes the bit stream (i) and generates decoded pictures. The decoded pictures are input as input decoded pictures to a frame memory 33 through a recording/reproducing system having a magnetic tape or the like.

The frame memory 33 supplies the input decoded pictures to an MPEG encoder 34 and an MAD calculating circuit 35. The MPEG encoder 34 re-encodes the input decoded pictures. The input decoded pictures are supplied to the MPEG encoder 34 with a delay necessary for determining the picture type. The MAD calculating circuit 35 calculates MAD values and supplies the calculated results to a high pass filter 36.

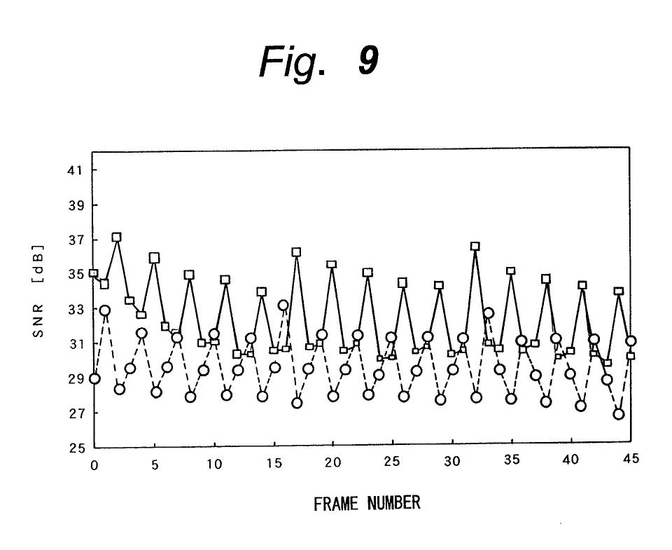

As described above, the high pass filter 36 may be a high pass filter with three taps [−1/2, 1, and −1/2]. The high pass filter 36 performs a filtering process for extracting high frequency components from the calculated results of the MAD values. Namely, a signal shown in FIG. 9 is extracted and supplied to a B picture determining circuit 37. The B picture determining circuit 37 determines the picture type corresponding to the received signal.

A signal that represents the picture type is supplied to the MPEG encoder 34. With reference to such a signal, the MPEG encoder 34 locks GOP phases of the input decoded pictures that have been delayed and received from the frame memory 33. The MPEG encoder 34 outputs a bit stream (o) as the re-encoded results of which GOP phases of decoded pictures are locked.

In the above-described example, it is determined whether or not B picture phases lock. Corresponding to the determined result, decoded pictures are re-encoded in the state that B picture phases lock. When an original B picture is treated as an I picture or a P picture, picture quality in the re-encoding process largely deteriorates. However, according to the present invention, the probability of which such a problem takes place can be decreased. When an original P picture is treated as an I picture, picture quality in the re-encoding process slightly deteriorates. Thus, such a problem is ignorable. When a process for locking I picture phases or P picture phases is used, GOP phases can be fully locked as will be described as a second embodiment of the present invention.

According to the first embodiment of the present invention, the picture type is determined corresponding to only input decoded pictures. Alternatively, the deviation of GOP phases may be determined corresponding to input decoded pictures and re-decoded pictures (of which a picture signal that has been re-encoded is decoded). Hereinafter, the re-decoded pictures are referred to as decoded pictures in the re-encoding process. With reference to the determined result, the picture type may be determined.

Next, the second embodiment of the present invention will be described. In the second embodiment, a signal-noise ratio (SNR) value is calculated with input decoded pictures and re-decoded pictures of which the input decoded pictures are re-encoded and then re-decoded. The deviation of GOP phases is determined by comparing the picture quality of the calculated values. As a structure for re-decoding a picture signal generated in the re-encoding process and obtaining decoded pictures in the re-encoding process, a local decoder may be disposed in an encoder that performs the re-encoding process.

In the second embodiment, as a GOP structure, the intervals of I pictures or P pictures should be 3 or more. In addition, the GOP structure should be known. These conditions are required for the second embodiment as will be described later. The SNR value is calculated corresponding to formula (5).

$$\begin{matrix}SNR = 20 log \frac{255}{MeanError} \\ MeanError is calculated as follows : \\ MeanError = \sqrt{\frac{SumError}{pixel\_num}}\end{matrix} \qquad ( 5 )$$

where pixel_num is the number of pixels of one screen; and SumError is the sum of squares of differences between pixel values of an input decoded picture and pixel values of a re-decoded picture of which the input decoded picture is re-encoded and re-decoded.

Next, a method for detecting the deviation of GOP phases corresponding to SNR values will be described. FIG. 9 is a graph showing the variation of SNR values in the case that a GOP structure with n=15 and m=3. In FIG. 9, the horizontal axis represents frame numbers. In FIG. 9, SNR values are denoted by squares and solid lines in the case that the re-encoding process is performed with GOP phases that fully lock. In this case, the variation of SNR values corresponds to the GOP structure that follows:

BBIBBPBBPBBPBBPBBIBBPBBPBBPBBPBBIBBPBBPBBPBBP . . .

The SNR values of the first two B pictures are small. The SNR value of the next I picture is large. Generally, this SNR value is maximum in one GOP. The SNR values of the next two successive B pictures are small. Thereafter (after the sixth picture), three sets of one P picture and two B pictures take place. Thereafter, a P picture takes place. With these pictures, one GOP is completed. Thus, FIG. 9 shows the variation of SNR values of frames of around three GOPs.

On the other hand, in the state that a B picture phase deviates from an I picture phase or a P picture phase (hereinafter, this state is referred to as state that GOP phases fully deviate), SNR values of re-decoded pictures vary as denoted by circles and dashed lines. FIG. 9 shows SNR values in the state that GOP phases fully deviate as a GOP structure that follows:

Input decoded pictures:

BBIBBPBBPBBPBBPBBIBBPBBPBBPBBPBBIBBPBBPBBPBBP

Pictures in re-encoding process:

BIBBPBBPBBPBBPBBIBBPBBPBBPBBPBBPBIBBPBBPBBPBBP

As is clear from FIG. 9, in the state that GOP phases fully lock, the difference between SNR values of two successive B pictures is small. On the other hand, in the state that GOP phases fully deviate, the difference between SNR values of two successive B pictures is large. With this characteristic, the state that GOP phases fully deviate can be determined. This determining method is available in a GOP structure of which at least two B pictures succeed. Thus, the second embodiment of the present invention is available in the condition that m is 3 or more. In the determining method, when the state that GOP phases fully deviate is detected, the encoder performs a process for locking B picture phases.

In reality, the determining process is performed as follows. For example, points are assigned corresponding to the absolute value of the difference of SNR values. When the total points of a GOP exceed a predetermined threshold value, a process for determining that GOP phases fully deviate is performed. In reality, even in the state that GOP phases fully lock, the difference between SNR values may be large. However, in the state that GOP phases fully deviate, the situation of which the difference between SNR values is small hardly takes place. Thus, when large points are assigned to a set of SRN values whose difference is large, the determination can be performed without an error.

Next, the state that GOP phases do not fully deviate will be described. In this case, since B phases lock, the state that GOP phases fully lock or the state that the an I picture phase deviates from a P picture phase takes place.

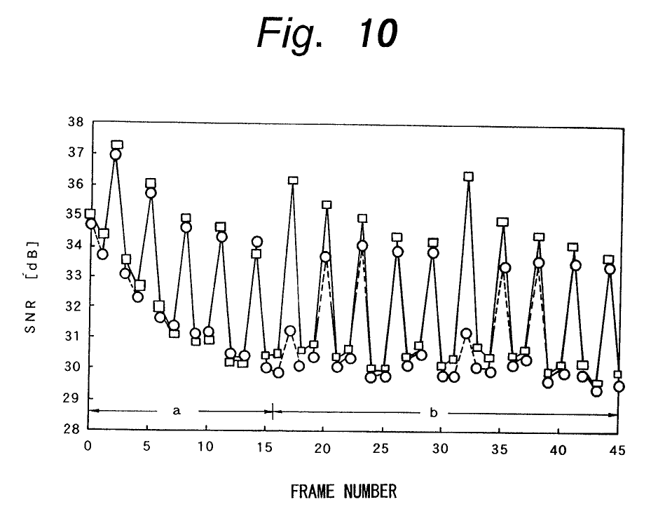

Next, a method for determining which of two states takes place will be described. In FIG. 10, the state that GOP phases fully lock is denoted by squares and solid lines. On the other hand, the state that an I picture phase deviates from a P picture phase is denoted by circles and dotted lines (when a solid line overlaps with a dotted line, only the solid line is apparently illustrated). FIG. 10 shows SNR values in the state that an I picture phase deviates from a P picture phase as a GOP structure that follows:

Input decoded pictures:

BBIBBPBBPBBPBBPBBIBBPBBPBBPBBPBBIBBPBBPBBPBBP

Pictures in re-encoding state:

BBIBBPBBPBBPBBPBBPBBIBBPBBPBBPBBPBBIBBPBBPBBP

As described above, in the state that GOP phases fully lock, the SNR value of an I picture becomes maximum in one GOP. Corresponding to the characteristic, it can be determined whether the state that GOP phases fully lock or the state that an I picture phase deviates from a P picture phase takes place. In reality, when an I picture is treated as a P picture in the re-encoding process, the SNR value sometimes largely decreases in the GOP. For example, in the 17-th frame, since an I picture of input decoded pictures is treated as a P picture in the re-encoding process, the SNR value largely decreases.

Thus, the position of which a P picture of input decoded pictures has been substituted with an I picture in the re-encoding process due to the deviation of phases can be detected. Corresponding to the detected result, a process for locking an I picture phase with a P picture phase can be performed.

When the determination for the deviation of GOP phases is performed with a small amount of data such as one GOP (see FIGS. 9 and 10), the determined result may contain an error. However, when the determination is performed for data of several GOPs and the phase matching process is performed corresponding to the determined result, GOP phases can be securely locked.

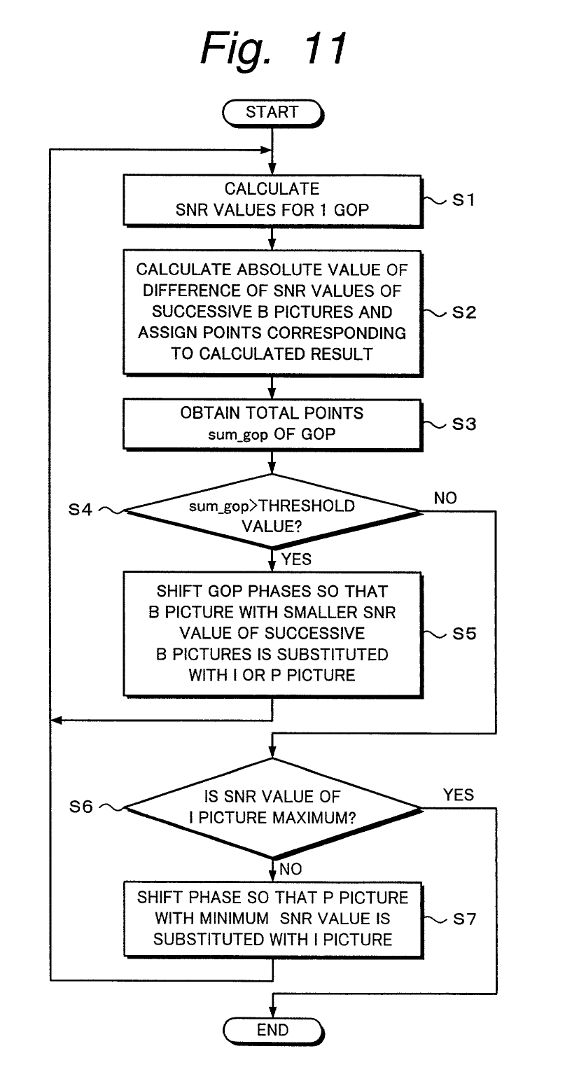

Next, with reference to a flow chart shown in FIG. 11, a real process for locking GOP phases will be described. After the process is started, at step S1, SNR values for one GOP are calculated corresponding to formula (5). At step S2, the absolute value of the difference between SNR values of successive B pictures is calculated. Points are assigned corresponding to the calculated value. At step S3, the total points sum_gop of the GOP are obtained. At step S4, it is determined whether or not sum_gop is larger than a predetermined threshold value.

When the determined result at step S4 is Yes, since B picture phases deviate, the flow advances to step S5. At step S5, GOP phases are shifted so that a B picture with the minimum SNR value is treated as an I picture or a P picture. Thereafter, the flow returns to step S1.

When the determined result at step S4 is No, since B picture phases lock, the flow advances to step S6. At step S6, it is determined whether or not the SNR value of an I picture in the GOP is maximum.

When the determined result at step S6 is No, since an I picture phase deviates from a P picture phase, the flow advances to step S7. At step S7, GOP phases are shifted so that a P picture with the minimum SNR value in the GOP is substituted with an I picture. Thereafter, the flow returns to step S1.

On the other hand, when the determined result at step S6 is Yes, an I picture phase locks with a P picture phase. Thus, in this case, since GOP phases fully lock, the process for the GOP is completed. In such a manner, the GOP phases of all the pictures are locked.

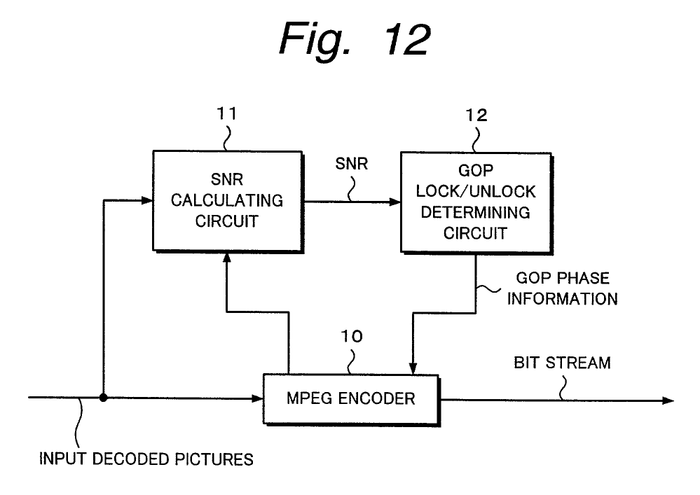

Next, with reference to FIG. 12, the structure of the second embodiment of the present invention will be described. Input decoded pictures are supplied to an MPEG encoder 10 and an SNR calculating circuit 11. The MPEG encoder 10 re-encodes the input decoded pictures. The MPEG encoder 10 has a local decoder. The local decoder decodes the re-encoded picture signals and generates re-decoded pictures.

The re-decoded pictures are supplied to the SNR calculating circuit 11. The SNR calculating circuit 11 calculates SNR values with the input decoded pictures and re-decoded pictures of which the input decoded pictures are re-encoded and re-decoded (see Formula (5) and step S1). The calculated SNR values are supplied to a GOP lock/unlock determining circuit 12. The GOP lock/unlock determining circuit 12 determines the deviation of GOP phases in the above-described determining method, generates GOP phase information signal corresponding to the determined result, and supplies the generated signal to the MPEG encoder 10. When necessary, the MPEG encoder 10 performs a GOP phase shifting process with reference to the GOP phase information signal. Thereafter, the MPEG encoder 10 outputs re-encoded pictures as a bit stream.

In the example, the MPEG encoder 10 has the local decoder. However, when the increase of the circuit scale is permitted, an MPEG encoder and an MPEG decoder that determine GOP phases may be disposed along with the MPEG decoder that performs the re-encoding process.

According to the first and second embodiments of the present invention, an inter-picture compression encoding process corresponding to the MPEG standard (in particular, MPEG2 standard) is performed as a precondition. However, the present invention can be applied to other encoding processes as long as an encoded signal is composed of a plurality of types of pictures and a sequence of pictures is repeated in an encoded signal. In other words, the present invention can be applied to an inter-picture compression encoding process corresponding to the MPEG4 standard or MPEG7 standard.

As described above, according to the present invention, the picture type of each picture of input decoded pictures is determined corresponding to a value that represents an information amount assigned to each picture in the first encoding process. With reference to the determined result, a process for locking GOP phases is performed.

In addition, according to the present invention, the deviation of GOP phases of input decoded pictures that are input to an encoder that performs a re-encoding process from GOP phases of decoded pictures that have been re-encoded is determined with the input decoded pictures and the re-decoded. With reference to the determined result, GOP phases are locked.

Thus, since the re-encoding process can be performed with correct GOP phases, the deterioration of picture quality in the re-encoding process due to the deviation of GOP phases can be suppressed.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. An inter-picture compression encoding apparatus, comprising:
inputting means for receiving decoded pictures;
picture type information generating means for generating a signal that represents a picture type corresponding to the decoded picture; and
GOP phase deviation determining means for determining the deviation of GOP phases corresponding to the output signal of said picture type information generating means.

2. The inter-picture compression encoding apparatus as set forth in claim 1,
wherein said picture type information generating means including:
information amount calculating means for calculating a value that represents an information amount assigned to each picture corresponding to the decoded pictures.

3. The inter-picture compression encoding apparatus as set forth in claim 2,
wherein said information amount calculating means calculates a value that represents an information amount of each pixel corresponding to a pixel value that is assigned to each pixel of a picture with reference to a predetermined threshold value, and
wherein said information amount calculating means adds the values that represent the information amounts of the pixels of the picture so as to calculate the value that represents the information amount assigned to each picture.

4. The inter-picture compression encoding apparatus as set forth in claim 1,
wherein the GOP phases are locked corresponding to the determined result of said GOP phase deviation determining means.

5. An inter-picture compression encoding apparatus, comprising:
inputting means for receiving decoded pictures;
encoding means for encoding the decoded pictures;
decoding means for decoding encoded pictures so as to generate re-decoded pictures;
picture quality deterioration evaluating means for calculating a value that represents the deterioration of the picture quality for each picture of a GOP corresponding to the decoded pictures and the re-decoded pictures; and
GOP phase deviation detecting means for detecting the deviation of GOP phases corresponding to a value that represents the deterioration of the picture quality.

6. The inter-picture compression encoding apparatus as set forth in claim 5,
wherein said GOP phase deviation detecting means detects the deviation of the GOP phases corresponding to a value that represents the deterioration of the picture quality of a plurality of pictures estimated as a predetermined number of successive B pictures corresponding to a GOP structure.

7. The inter-picture compression encoding apparatus as set forth in claim 5,
wherein said GOP phase deviation detecting means determines whether or not the value that represents the deterioration of the picture quality of a picture that is estimated as an I picture corresponding to a GOP structure is the maximum value of the GOP so as to determine the deviation of the GOP phases corresponding to the determined result.

8. The inter-picture compression encoding apparatus as set forth in claim 5,
wherein the value that represents the deterioration of the picture quality is signal noise ratio.

9. The inter-picture compression encoding apparatus as set forth in claim 5,
wherein the GOP phases are locked corresponding to the determined result of said GOP phase deviation detecting means.

10. An inter-picture compression encoding method, comprising the steps of:
receiving decoded pictures;
generating a signal that represents a picture type corresponding to the decoded pictures; and
determining the deviation of GOP phases corresponding to the output signal at the picture type information generating step.

11. An inter-picture compression encoding method, comprising the steps of:
receiving decoded pictures;
encoding the decoded pictures;
decoding encoded pictures so as to generate re-decoded pictures;
calculating a value that represents the deterioration of the picture quality for each picture of a GOP corresponding to the decoded pictures and the re-decoded pictures; and
detecting the deviation of GOP phases corresponding to a value that represents the deterioration of the picture quality.
